(19) United States
(12) Patent Application Publication
(10) Pub. No.: US 2008/0221995 A1
(43) Pub. Date: Sep. 11, 2008

(54) METHOD AND SYSTEM FOR ASSOCIATING RICH CONTENT WITH A RICH MEDIA CONTENT

(76) Inventors: Jayant Kadambi, Mountain View, CA (US); Ayyappan Sankaran, San Jose, CA (US); Michael Lu, Tracy, CA (US)

Correspondence Address: Global IP Services, PLLC, 198 F, 27th Cross, 3rd Block, Jayanagar, Bangalore, Karnataka, 560011, IN

(21) Appl. No.: 12/045,044

(22) Filed: Mar. 10, 2008

Related U.S. Application Data
(60) Provisional application No. 60/894,197, filed on Mar. 10, 2007.

(51) Int. Cl. G06Q 30/00; G06F 17/30

(52) U.S. Cl. 705/14; 707/1; 707/E17.001

(57) ABSTRACT

A method and system for associating one or more rich contents with a rich media content. According to the method a user plays a rich media content which includes an embedded calling script. Upon playing of the rich media content, the calling script is executed. Thereafter, one or more rich contents are associated with the rich media content based on the execution of the calling script. After associating of one or more rich contents, the one or more rich contents are played along with the rich media content.

### RELATED APPLICATIONS

Benefit is claimed under 35 U.S.C. 119(e) to U.S. Provisional Applications Ser. 60/894,197, entitled “SYSTEM AND METHOD FOR ASSOCIATING AN ADVERTISEMENT WITH A RICH MEDIA CONTENT” by Jayant Kadambi et al., filed on Mar. 10, 2007 which is herein incorporated in its entirety by reference for all purposes.

### FIELD OF THE INVENTION

The invention relates generally to monetizing rich media content. More specifically, the invention relates to associating one or more rich contents with rich media content.

### BACKGROUND OF THE INVENTION

The Internet has revolutionized the way information is shared across the globe. Vast amount of information of various types is available on the Internet today. The information ranges from educational information to recreational information. Generally, the recreational information is in the form of rich media content. Typically, an owner generate rich media content and a publisher publishes the rich media content of the owner over the Internet. After publishing, a plurality of users may access the rich media content.

Time and again, the rich media content is published along with other information rather than standalone, for instance, one or more rich contents may be played along with a rich media content. As an example, the rich content may be additional information related to the subject of rich media content. For instance, an owner generating a video on robotics may wish to inform viewer of a workshop on robotics which he/she may be planning to conduct.

Additionally, this also gives an opportunity for advertisers to reach the end consumers using the Internet in a targeted manner. Recent times have seen an explosive growth in the online advertisement industry and advertisers are targeting all the users accessing various rich media contents on the internet. Advertisers put one or more advertisements in the form of rich contents, along with the rich media content and pay a fee for the advertisements played. This also gives an incentive to the owners to generate the rich media content which may interest users from across the globe, and monetize their rich media content.

In existing techniques for monetizing rich media content, an owner of the rich media content strikes a deal with a publisher and uploads his rich media content on the publisher's website. Thereafter, the publisher strikes another deal with advertisers for advertising on the owner's rich media content. The process becomes difficult if the owner wishes to publish his content with multiple publishers. The owner has to sign multiple deals with the publishers making the process cumbersome for the owner. Further, the owner has to rely on the skills of individual publishers to strike a deal for monetization of his rich media content.

Moreover, such existing techniques embed the rich contents in the rich media content. However, a rich content may be a limited time information and may expire after a certain period of time. Therefore, it becomes cumbersome to change rich contents after publishing the rich media content if a rich content is embedded in the rich media content.

Therefore, there is a need for a method and system which simplifies a process of associating of one or more advertisements with rich media content, thereby allowing easy monetization to one or more content owners and/or publishers.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram showing an exemplary environment in which various embodiments of the invention can function.

FIG. 2 illustrates a flow diagram of a method for associating one or more rich contents with a rich media content in accordance with an embodiment of the invention.

FIG. 3 illustrates a flow diagram of a method for associating one or more rich contents with a rich media content in accordance with another embodiment of the invention.

FIG. 4 illustrates a block diagram of a system for associating one or more rich contents with a rich media content in accordance with an embodiment of the invention.

FIG. 5 illustrates a block diagram of a server for associating one or more rich contents with a rich media content in accordance with another embodiment of the invention.

FIG. 6 illustrates an exemplary embodiment of a method for associating one or more rich contents with a rich media content.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for associating a rich content with a rich media content. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide method and system for associating one or more rich contents with a rich media content. An owner generates a rich media content and, thereafter, a calling script is embedded in the rich media content. After embedding the calling script, one or more publishers publish the rich media content over a communication network. The rich media content published over the communication network may be played by a plurality of users. Upon playing by one or more users, the calling script embedded in the rich media content is executed and one or more rich contents are selected based on a set of predefined rules. Thereafter, the one or more rich contents are played in conjunction with the rich media content.

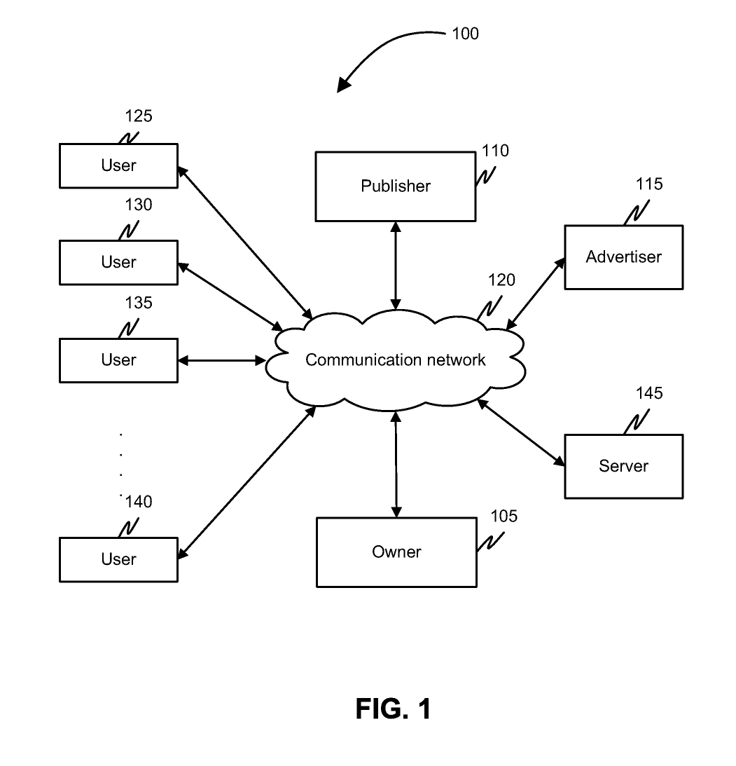

FIG. 1 is a block diagram showing an exemplary environment 100 in which various embodiments of the invention may function. Environment 100 includes an owner 105, a publisher 110 and an advertiser 115. Each of owner 105, publisher 110 and advertiser 115 are adaptively coupled to a communication network 120. Examples of the communication network 100 can include one or more of, but not limited to, the Internet, a Local Area Network (LAN), a wireless LAN and a mobile communication network. Owner 105 may generate a plurality of rich media contents to be published over communication network 120. Examples of a rich media content include, but are not limited to, a computer generated animation video, a movie video, a home made video, a multimedia clip, a Multimedia Messaging Service (MMS) message, an audio clip and a text message. The rich media content is published by publisher 110 over communication network 120. For instance, publisher 110 may publish one or more rich media contents over a website of publisher 110. Alternatively, owner 105 may also self-publish one or more rich media contents over his website. After publishing, a rich media content can be played by a user 125, a user 130, a user 135 and a user 140, each user is adaptively coupled to communication network 120. A user may play the rich media content over communication network 120 using one or more of, but not limited to, a cell phone, a Personal Digital Assistant (PDA), a computer, a laptop, a palmtop and an e-book.

Upon playing the rich media content by a user, one or more rich contents are associated with the rich media content by a server 145. A rich content may include one or more of, but not limited to, an animation, a video, an audio, an image, a text message, an advertisement, a limited time promotional offer, a social welfare message, and a logo of a company. Thereafter, the rich content may be played in conjunction with the rich media content. Although, FIG. 1 shows one owner 105, one advertiser 115 and one publisher 110, a person skilled in art will appreciate that there may be any number of owners, publishers, advertisers and users adaptively coupled to communication network 120.

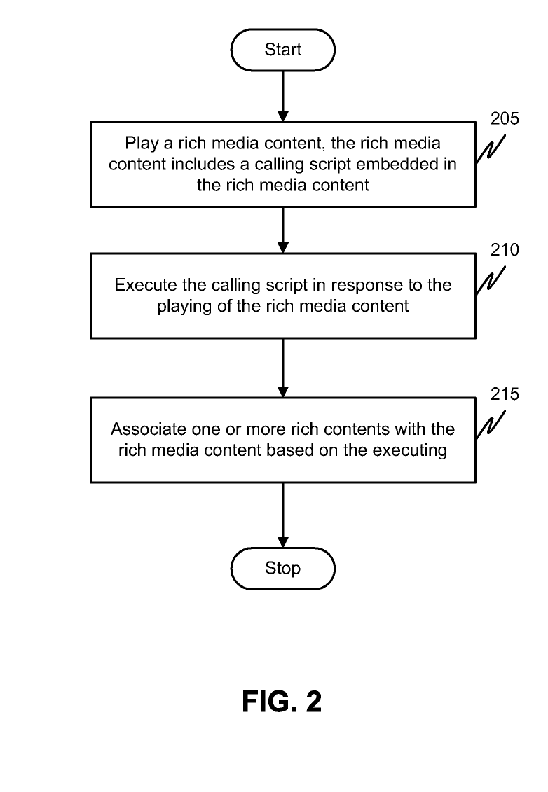

FIG. 2 is a flow diagram of a method for associating one or more rich contents with a rich media content in accordance with an embodiment of the invention. As explained in conjunction with FIG. 1, owner 105 generates one or more rich media contents and, thereafter, a calling script is embedded in each rich media content. The calling script may be embedded by one of owner 105, publisher 110, server 145, advertiser 115 and a third party service. After embedding of a calling script, the one or more rich media contents are published over communication network 120 by publisher 110. Publisher 110 can reformat the rich media content or change the encoding of the rich media content, for instance, to reduce the size of the rich media content. Once the one or more rich media contents are published, user 125 may play a rich media content, at step 205. User 125 may play the rich media content online. Alternatively, user 125 may download the rich media content to his/her device for playing the rich media content. A person skilled in the art appreciates that publisher 110 may allow user 125 to download the rich media content or may not allow a user to download the rich media content depending upon a policy of publisher 110. Further, a plurality of users may simultaneously play the rich media content over communication network 120.

After playing of the rich media content, the calling script embedded in the rich media content is executed, at step 210. Upon execution, the calling script communicates with server 145 and places a request for one or more rich contents to be associated with the rich media content. In an embodiment of the invention, the calling script may generate a context data corresponding to the playing of the rich media content. The context data can include one or more of, but is not limited to, a user information, a rich media content information and an owner information. The user information can include one or more of, but not limited to, a geographical location of the user, preferences of the user, language spoken by the user, demographic information of the user, psychographic information of the user, number of times the user watched the rich media content, a profile of the user, behavioral information of the user, for instance, did the user watch the rich media content before etc. Further, the rich media content information can include one or more of, but is not limited to, an identification (ID) number assigned to the rich media content for identification of the content, a type of rich media content, for instance, if the rich media content is a movie trailer or a song etc., or a genre of rich media content such as comedy, new etc. The owner information can be an identification (ID) number assigned to an owner for identification of the owner etc.

In a scenario a plurality of users may play the rich media content simultaneously, in this case the calling script generates a context data corresponding to the playing of the rich media content by each user. Thereafter, the calling script sends the context data corresponding to playing of the rich media content corresponding to each user to server 145 along with the request for one or more rich contents.

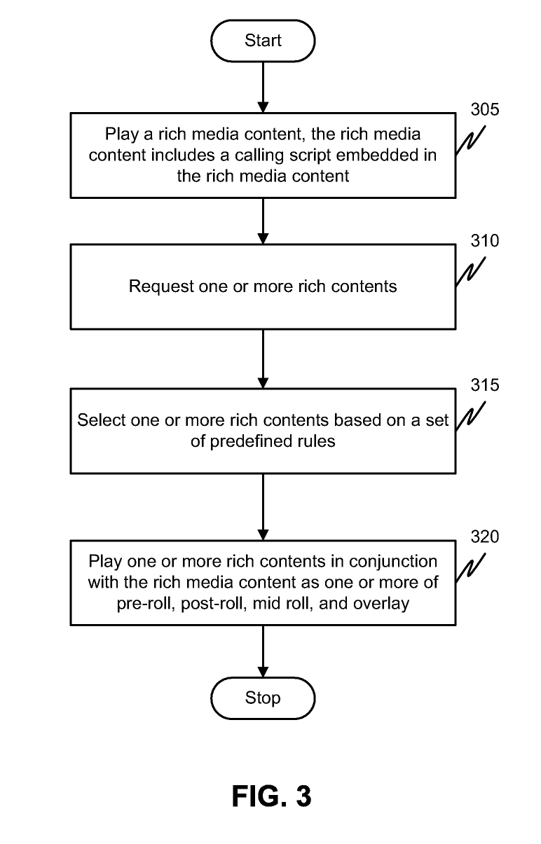

After receiving the request for one or more rich contents, server 145 associates one or more rich contents with the rich media content, at step 215. Server 145 may associate one or more rich contents based on a set of predefined rules. The set of predefined rules may use the context data for associating one or more rich contents. This is explained in further detail in conjunction with FIG. 3. In an embodiment of the invention, when a plurality of users are playing the rich media content simultaneously, server 145 may associate different rich contents for different users playing the video simultaneously based on the set of predefined rules. In this case, each user of the plurality of users may watch a different rich content associated with the rich media content even if each user is playing the rich media content simultaneously.

In an embodiment of the invention, server 145 may store one or more rich contents which may be associated with the rich media content corresponding to the calling script. Alternatively, server 145 may communicate with advertiser 115 for associating one or more rich contents with the rich media content corresponding to the calling script. In another embodiment of the invention, the calling script may directly communicate with advertiser 115 for associating one or more rich contents. For example, the calling script may send a context data which may include an ID number of the rich media content to advertiser 115. Thereafter, advertiser 115 may associate one or more rich media contents with the rich media content based on the ID number. In a scenario, server 145 may not associate any rich content based on the set of predefined rules. As an example, consider a case when server 145 includes limited time promotional offers which are expired. In this case, server 145 may not associate any rich content with the rich media content.

After associating one or more rich contents with the rich media content, one or more rich contents may be played in conjunction with the rich media content as one or more of pre roll, mid roll, post roll and overlay. For instance, server 145 may send a play information along with one or more rich contents. The play information may include rules for playing the rich contents in conjunction with the rich media contents. In an exemplary embodiment, a rule in play information can include, but is not limited to, play a rich content as one or more of pre roll, mid roll, post roll and overlay.

Consider a case when a rich media content RMC is associated with four rich contents, RC1, RC2, RC3 and RC4 by server 145 based on the set of predefined rules. Play information may include instructions for playing RC1 as pre roll, RC2 as mid roll, RC3 as post roll and RC4 and overlay. In this case, the RC1 is played before playing of RMC, i.e. as pre roll, RC2 is played in between the playing of RMC, i.e. as mid roll and RC3 is played after the playing of RMC, i.e. as post roll. Additionally, RC4 is played as an overlay, i.e. simultaneously along with the RMC. For instance, RC4 may be displayed as a transparent rich content in the top right corner of screen of user device playing the RMC.

FIG. 3 is a flow diagram of a method for associating one or more rich contents with a rich media content in accordance with another embodiment of the invention. According to the method, a user plays a rich media content published by publisher 110 over communication network 120, at step 305. The rich media content includes a calling script which is embedded in the rich media content. As explained earlier, the calling script is embedded in the rich media content before publishing of the rich media content over communication network 120. Upon playing of the rich media content, the calling script is executed. The calling script may generate a context data corresponding to the playing of the rich media content, in response to the execution. The context data can include one or more of, but is not limited to, a user information, a rich media content information and an owner information. This is explained in conjunction with FIG. 2.

Thereafter, at step 310, the calling script requests one or more rich contents from server 145. The calling script may send the context data along with the request. The context data corresponds to the playing of the rich media content. After receiving the request for one or more rich contents, server 145 selects one or more rich contents based on a set of predefined rules, at step 315. The set of predefined rules includes rules for selecting one or more rich contents. Server 145 may use the context data corresponding to the playing of rich media content to evaluate one or more rules of the set of predefined rules. In an exemplary embodiment, a rule in the set of predefined rules can include, select a surfboard advertisement if the location of playing of the rich media content is a coastal area. Another rule in the set of predefined rules can include, select a razor advertisement if the profile of the person playing the video is male. This enables context based advertisement in the method of the invention.

In an embodiment of the invention, server 145 may store a plurality of rich contents and may select one or more rich contents from the plurality of rich contents. Alternatively, server 145 may communicate with advertiser 115 for selecting one or more rich contents. A person skilled in art appreciates that in some cases server 145 may not select any rich content for associating with the rich media content based on the set of predefined rules. This may optimize the advertisement costs for advertiser and may help in targeted marketing of its brand.

In another embodiment of the invention, the calling script may directly request one or more rich contents from advertiser 115 instead of server 145. In this case advertiser 115 selects one or more rich contents based on the set of predefined rules. Further, as explained earlier in case of server 145, advertiser 115 may not select any advertisement based on the set of predefined rules. Additionally, in a scenario when a user is playing the rich media content more than once, different rich contents may be selected for associating with the rich media content. As an example, consider a case when a user plays a rich media content in the morning, server 145 may select a rich content corresponding to an automatic coffee maker based on the set of predefined rules. Further, if the same user plays the same rich media content in the evening, server 145 may select a rich content corresponding to a dining place, based on the set of predefined rules.

After selecting one or more rich contents, server 145 may send the one or more rich contents to the user device where the rich media content is played. Thereafter, the one or more rich contents received are played in conjunction with the rich media content at step 320. The one or more rich contents may be played as one or more of, but not limited to, pre roll, mid roll, post roll and overlay in conjunction with the rich media content based on a play information. As explained earlier the play information may include the rules for playing one or more rich contents in conjunction with the rich media content. In an embodiment of the invention, the play information is supplied by one of server 145 and advertiser 115. Alternatively, the play information may be hard coded in the calling script at the time of embedding the calling script.

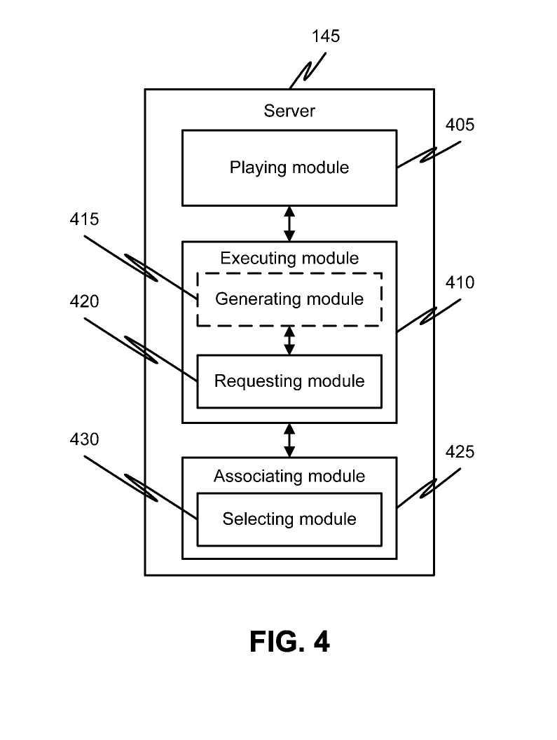

FIG. 4 is a block diagram of a system 400 for associating one or more rich contents with a rich media content in accordance with an embodiment of the invention. A user plays a rich media content published by publisher 110 over communication network 120, using a playing module 405. The rich media content includes a calling script which is embedded in the rich media content. As explained earlier, the calling script is embedded in the rich media content before publishing of the rich media content over communication network 120.

Once the rich media content is played, an executing module 410 executes the calling script. Executing module 410 may include a generating module 415 for generating a context data corresponding to the playing of the rich media content, in response to the execution of the calling script. The context data can include one or more of, but is not limited to, a location of playing of the rich media content, a frequency of playing of the rich media content, time of playing of the rich media content, profile of user playing the rich media content and type of user device used for playing the rich media content.

In an embodiment of the invention, playing module 405 and executing module 410 may be integrated as one entity. For instance, if a user plays the rich media content embedded with a calling script using his computer, a media player installed on the computer may act as each of playing module 405 and executing module 410. In this case, upon a request from the user, the media player plays the rich media content as well as executes the calling script embedded in the rich media content.

In response to the execution of the calling script, a request for one or more rich contents is placed with server 145 by a requesting module 420. Requesting module 420 may also send the context data along with the request to server 145. After requesting module 420 places the request, an associating module 425 associates one or more rich contents. Associating module 425 may include a selecting module 430 for selecting one or more rich contents based on a set of predefined rules. The set of predefined rules may include rules for selecting one or more rich contents. This is explained in detail in conjunction with FIG. 3. Selecting module 430 may use the context data corresponding to the playing of rich media content to evaluate one or more rules of the set of predefined rules. In an embodiment of the invention, associating module 425 may store a plurality of rich contents and selecting module 430 may select one or more rich contents from the plurality of rich contents. Alternatively, selecting module 430 may communicate with advertiser 115 for selecting one or more rich contents to be associated with the rich media content.

After associating of the one or more rich contents, the one or more rich contents are played in conjunction with the rich media content by playing module 405. The one or more rich contents may be played as one or more of, but not limited to, pre roll, mid roll, post roll and overlay in conjunction with the rich media content based on the play information. As explained earlier the play information includes the rules for playing one or more rich contents in conjunction with the rich media content. In an embodiment of the invention, the play information is supplied by associating module 425. Alternatively, the play information may be hard coded in the calling script.

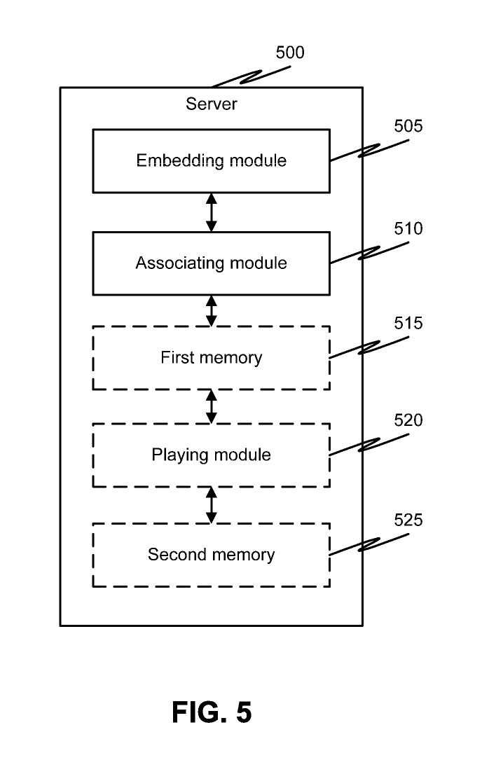

FIG. 5 illustrates a block diagram of a server 500 for associating one or more rich contents with a rich media content in accordance with another embodiment of the invention. Server 500 includes an embedding module 505 and an associating module 510. As explained earlier, an owner generates a rich media content and thereafter, embedding module 505 embeds a calling script in the rich media content. The owner of the rich media content may communicate with server 500 over communication network 120 for embedding the calling script. As an example, an owner may upload the rich media content on server 500 over the Internet for embedding the calling script. After embedding of the calling script, the rich media content is published over communication network 120. For publishing the rich media content, server 500 may include a first memory 515 which may store a plurality of rich media contents after embedding each rich media content with a corresponding calling script.

After publishing of the rich media content, a user may play a rich media content over communication network 120. Server 500 may include a playing module 520 for playing the rich media content. Alternatively, a user may download the rich media content and thereafter, play the rich media content using a player installed on a user's device. Examples of the player include, but are not limited to, a flash player, a windows media player and an mplayer. Upon playing the rich media content, the calling script embedded in the rich media content is executed. The calling script places a request for one or more rich contents with associating module 510.

In an embodiment of the invention, the calling script may generate a context data corresponding to the playing of the rich media content by the user and send the context data to associating module 510. Thereafter, associating module 510 associates one or more rich contents to the rich media content based on the set of predefined rules. The set of predefined rules may use the context data sent by the calling script along with the request for one or more rich contents. This is explained in detail in conjunction with FIG. 3. The one or more rich contents may be stored in a second memory 525 of server 500 and associating module 510 may select one or more rich contents from second memory 525 for associating with the rich media content. In response to the associating, playing module 520 plays the one or more rich contents in conjunction with the rich media content.

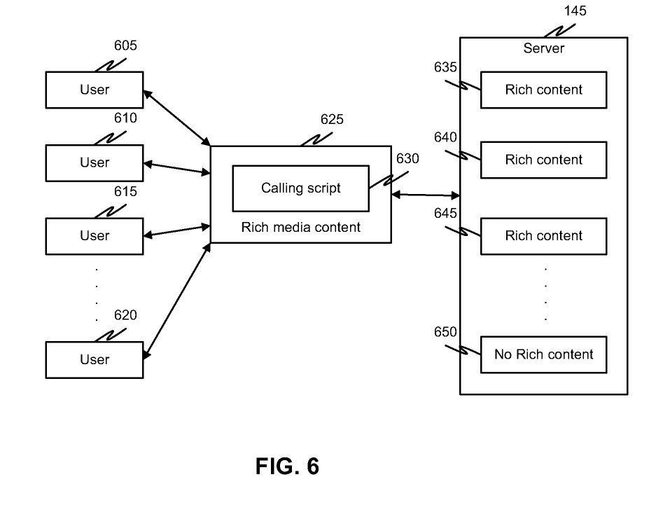

FIG. 6 illustrates an exemplary embodiment of a method for associating one or more rich contents with a rich media content. A user 605, a user 610, a user 615 and a user 620 may play a rich media content 625 on their respective computing systems. Rich media content 625 is embedded with a calling script 630. As mentioned earlier, an owner of rich media content 625, a publisher of rich media content 625, server 145 or a third party service can embed calling script 630 into rich media content 625. When user 605, user 610, user 615 and user 620 play rich media content 625, calling script 630 gets executed. Calling script 630 communicates with server 145 and places a request for one or more rich media contents. Calling script 630 may also generate a context data corresponding to the playing of rich media content 625 by each user, and may send the respective context data to server 145. As mentioned earlier, the context data can include, but is not limited to, user information, a rich media content information or an owner information. This is explained in detail in conjunction with FIG. 2.

In response to the request for one or more rich contents, server 145 selects one or more of a rich content 635, a rich content 640, a rich content 645 and a no rich content 650. Server 145 selects one or more rich contents based on a set of predefined rules using a corresponding context data obtained from playing of rich media content 625 by each of user 605, user 610, user 615 and user 620.

It shall be appreciated by those skilled in the art that server 145 may select different rich contents for different users based on the set of predefined rules, even if all the users are viewing same rich media content 625. For example, server 145 may select rich content 635 for user 605 and rich content 640 for user 610 even if each of user 605 and user 610 plays rich media content 625 at the same time. Further, server 145 may select different rich contents for a user playing same rich media content 625 multiple times, for instance, at different times of a day by the user. For example, server 145 may select rich content 635, if user 605 plays rich media content 625 in morning and rich content 640, if user 605 plays rich media content 625 in morning.

After selecting one or more rich content, server 145 sends one or more selected rich contents to calling script 630. Thereafter, the received one or more rich content are played along with the rich media content based on a play information. As explained earlier, the play information may be sent by server 145 along with the one or more rich media contents. Alternatively, the play information may be hard coded in calling script 630. In a scenario, server 145 may select no rich content 650. In this scenario, server 145 may not send a rich content and no rich content is played along with the rich media content.

The method and system of the invention allows an owner of a rich media content to monetize his rich media content in simplified manner. The invention allows the owner to publish his rich media content with multiple publishers in an efficient and simplified way. Further, the invention also allows the owner to efficiently monetize his content without relying on the skills a publisher to strike a deal with the advertisers. Furthermore, the invention simplifies the procedure for a publisher by reducing and/or eliminating for a need for managing advertisements for an owner.

What is claimed is:

1. A method of associating at least one rich content with a rich media content, the method comprising:
playing the rich media content, wherein the rich media content comprises a calling script embedded in the rich media content;
executing the calling script in response to the playing of the rich media content; and
associating at least one rich content with the rich media content based on the executing of the calling script.

2. The method of claim 1, wherein the rich media content is played online.

3. The method of claim 1, wherein the rich media content is downloaded to a user device for playing.

4. The method of claim 1, wherein the at least one rich content is at least one of an advertisement, a company logo, a company name, and a limited time promotional offer.

5. The method of claim 1, wherein the executing comprises:
generating a context data corresponding to the playing of rich media content; and
requesting at least one rich content in response to the generating of the context data.

6. The method of claim 5, wherein the context data comprises at least one of, a user information, a rich media content information and an owner information.

7. The method of claim 1, wherein the associating comprises:
selecting at least one rich content based on a set of predefined rules in response to the executing of the calling script.

8. The method of claim 1 further comprising:
playing the at least one rich content in conjunction with the rich media content as at least one of pre-roll, post-roll, mid roll and overlay.

9. The method of claim 1, wherein the rich content comprises at least one of an image, a video, an audio and a text.

10. The method of claim 1, wherein the rich media content comprises at least one of an image, a video, an audio and a text.

11. A system for associating at least one rich content with a rich media content, the method comprising:
a playing module, the playing module playing the rich media content, wherein the rich media content comprises a calling script embedded in the rich media content;
an executing module, the executing module executing the calling script in response to the playing of the rich media content; and
an associating module, the associating module associating at least one rich content with the rich media content based on the executing of the calling script.

12. The system of claim 11, wherein the executing module further comprises:
a generating module, the generating module generating a context data corresponding to the playing of rich media content; and
a requesting module, the requesting module requesting at least one rich content in response to the generating of the context data.

13. The system of claim 11, wherein the associating module comprises:
a selecting module, the selecting module selecting at least one rich content based on a set of predefined rules in response to the executing of the calling script.

14. A server for associating at least one rich content with a rich media content, the server comprising:
an embedding module, the embedding module embedding a calling script in the rich media content, wherein the calling script requests at least one rich content; and
an associating module, the associating module associating at least one rich content with the rich media content in response to a request from the calling script, the at least one rich content being associated based on a set of predefined rules.

15. The server of claim 14 further comprising:
a first memory, the first memory storing a plurality of rich media contents, wherein a calling script is embedded in each of the plurality of rich media contents; and
a playing module, the playing module playing at least one rich media content belonging to the plurality of rich media contents, the rich media content being played in response to a request from a user.

16. The server of claim 14 further comprising:
a second memory, the second memory for storing a plurality of rich contents.
